(19) United States
(12) Patent Application Publication
(10) Pub. No.: US 2004/0227360 A1
(43) Pub. Date: Nov. 18, 2004

(54) Double hooked adjustable window security clamp

(76) Inventor: Richard John Armstrong, Ventura, CA (US)

Correspondence Address: Richard John Armstrong, 8371 Eureka Street, Ventura, CA, 93004, US

(21) Appl. No.: 10/439,138

(22) Filed: May 15, 2003

(51) Int. Cl. E05C 19/18

(52) U.S. Cl. 292/260

(57) ABSTRACT

A generally double hooked adjustable window security clamp that allows a window to be opened only up to a predetermined amount. Said window security clamp functions to limit the travel of one window unit over another within an overall window frame whereby limiting the opening space in said overall window frame.

### CROSS REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention relates to a simple, inexpensive security device that can be easily installed, adjusted and removed without tools and, more specifically, to a security device for maintaining two or more window units within an overall frame in a partially opened position.

2. Background of Invention

There have been numerous prior attempts to develop window locking devices which will allow windows to be opened, but still remain locked so as to prevent unauthorized entry therethrough. However, no one of these prior attempts meets all of the following criteria: inexpensive; simple to install, adjust and remove without the use of tools; be applicable to more than one window and enable the windows to be closed without the device being adjusted.

### BACKGROUND OF INVENTION—OBJECTS AND ADVANTAGES

Accordingly, several objects and advantages of my adjustable window security clamp are:

(a) to provide an inexpensive device that secures windows partially open for ventilation but prevents access by unwanted intruders.

(b) to provide a window security device that is simple to install, adjust and remove without the use of tools.

(c) to provide a window security device that can be used on one or more windows.

(d) to provide a window security device that enables the windows to be closed without device adjustment or damage to the window. The vertical strap in my invention is of such dimensions and flexibility to pass between the upper and lower window units when fully closed without causing damage whereas in Dinan U.S. Pat. No. 5,125,699, Jun. 30, 1992 the structural requirements of the “long leg 36” are such that the required thickness of the member would damage the window units if closed as shown in the attached FIG. 4 and FIG. 12.

Other objects and advantages are to provide an adjustable window security clamp which locks a window partially closed to prevent people falling out, which prevents unauthorized opening of the window, which can quickly be removed in case of fire or other emergency, which can be installed without destructive effects to existing structures, which has an aesthetic appearance and which is durable in use.

Further objects and advantages of my adjustable window security clamp will become apparent from a consideration of the drawings and ensuing description.

### SUMMARY

An adjustable window security clamp comprising two vertically and horizontally opposed hooks connected by a strap of variable effective length.

### DRAWINGS—FIGURES

FIG. 1 shows an isometric view of the adjustable window security clamp in place in a double hung window.

FIG. 2 shows an isometric view of the security clamp.

FIG. 3 shows a side elevation of the security clamp in place in a double hung window in the open position.

FIG. 4 shows a side elevation of the security clamp in place in a double hung window in the closed position

FIG. 5 shows a section through the upper hook.

FIG. 6 shows a section through the lower hook.

FIG. 7 shows an elevation of the vertical steel strap.

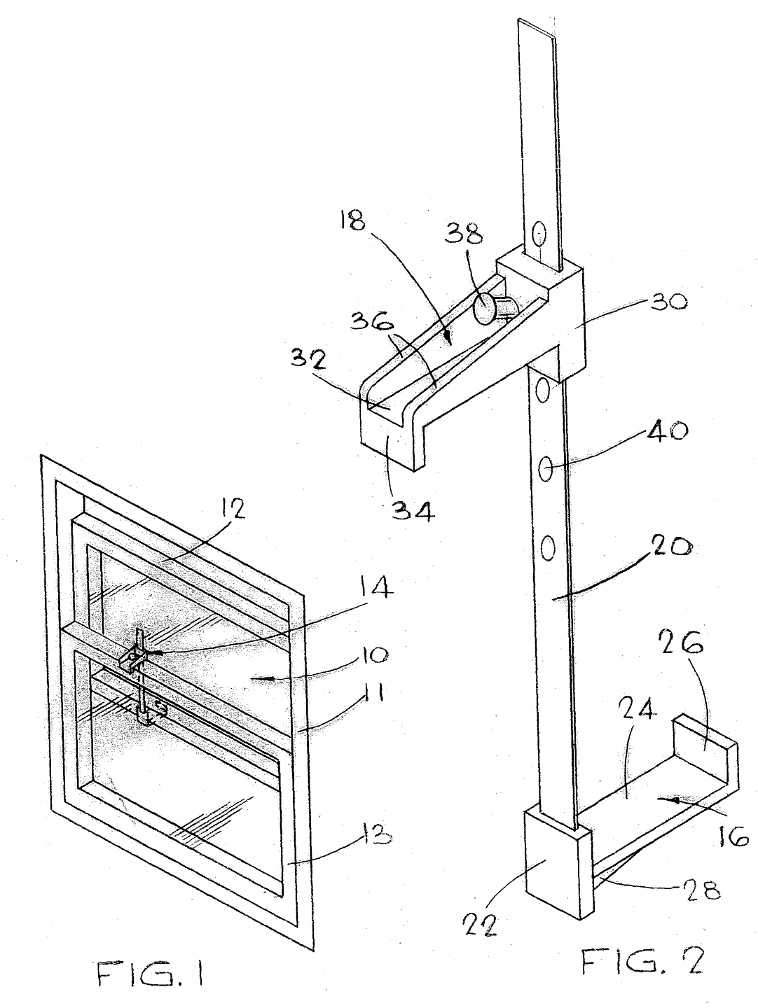

DRAWINGS - - Reference Numerals

| | |
|---|---|
| 10 | Window |
| 11 | Window Frame |
| 12 | Upper Sash Frame |
| 13 | Lower Sash Frame |
| 14 | Security Clamp |
| 16 | Lower Hook |
| 18 | Upper Hook |
| 20 | Vertical Steel Strap |
| 22 | Lower Hook Vertical Portion |
| 24 | Lower Hook Horizontal Portion |
| 26 | Lower Hook Vertical Portion |
| 28 | Lower Hook Rib |
| 30 | Upper Hook Vertical Portion |
| 32 | Upper Hook Horizontal Portion |
| 34 | Upper Hook Vertical Portion |
| 36 | Upper Hook Rib |
| 38 | Thumbscrew |
| 40 | Screw Openings |

### DETAILED DESCRIPTION—PREFERRED EMBODIMENT

With reference to the drawings the numeral 10 refers generally to a window comprising an overall frame 11 having upper and lower window units 12 and 13 slidably mounted therein. The adjustable window security clamp of this invention is referred to generally by the reference numeral 14.

Said adjustable window security clamp 14 generally comprises two vertically opposed clamp hooks 16 and 18 attached in opposite directions on a half inch wide by 20 gauge thick vertical steel strap 20. The lower hook 16 generally comprises an h-shape with a vertical portion 22 rigidly attached onto the lower end of said strap 20, a horizontal portion 24 extends from the center of the said vertical portion 22 and terminates in a second shorter vertical portion 26. A rib 28 between said vertical portion 22 and said horizontal portion 24 provides additional stiffness. The upper hook 18 also generally comprises an h-shape shape with a vertical portion 30 slidably mounted around said strap 20, a horizontal portion 32 extends from the center of the said vertical portion 30 and terminates in a second shorter vertical portion 34. Ribs 36 between said vertical portion 30 and said horizontal portion 32 provide additional stiffness. The said upper hook 18 also contains a thumbscrew 38 that is mounted in a threaded opening formed in said vertical portion 30. The vertical steel strap 20 is rigidly attached to said lower hook 16 and slidably attached to said upper hook 18 and is provided with a plurality of spaced-apart screw openings 40 formed therein and extending therethrough.

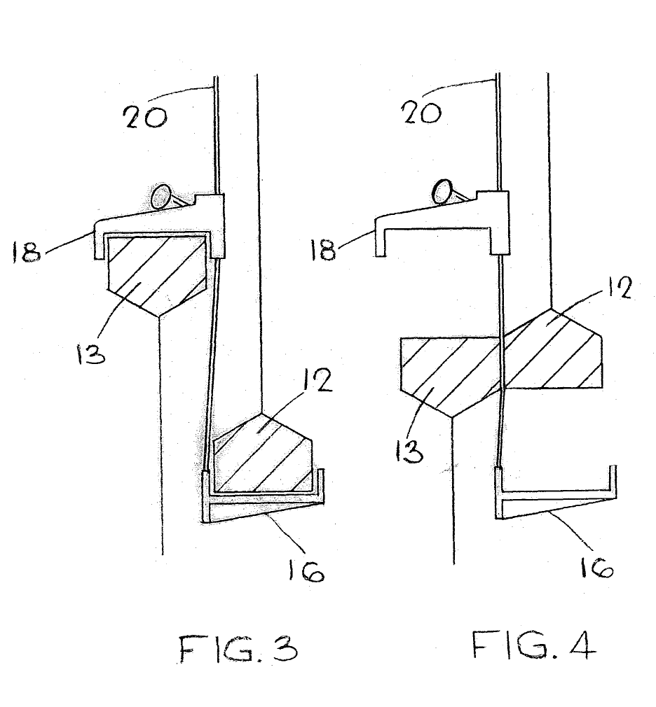

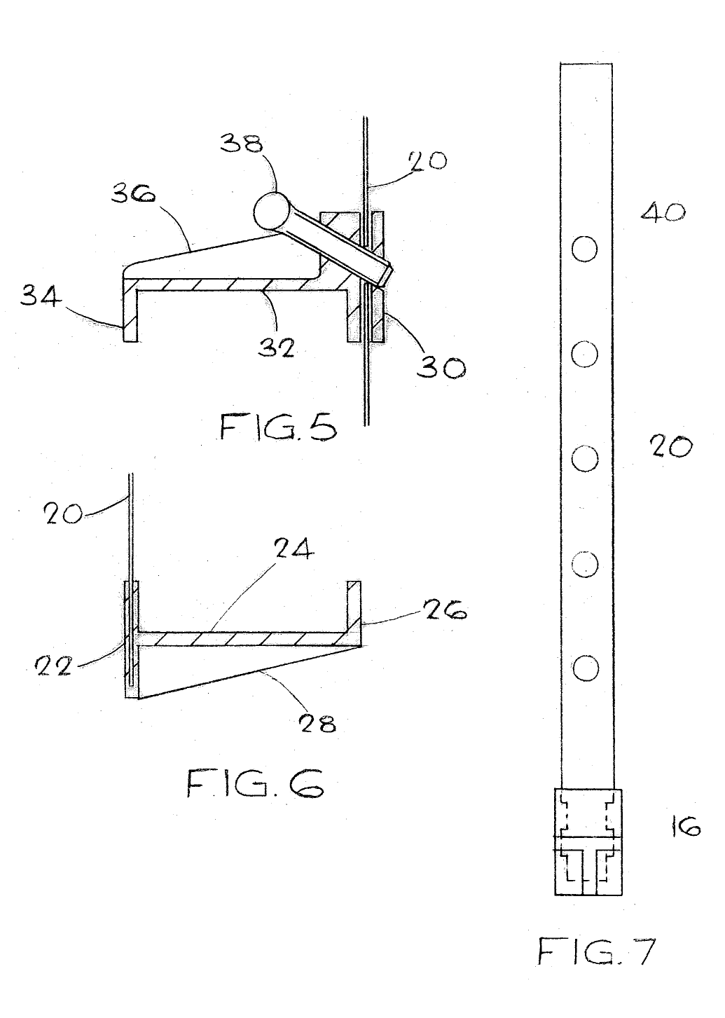

The said vertical steel strap 20 is passed between the two said slidable open window units 12 and 13 as illustrated in FIG. 3 and said lower hook 16 is placed under said upper window unit 12 with said vertical portion 26 hooking around said window unit 12 to limit horizontal motion of said lower hook 16. Said upper hook 18 slides down said vertical steel strap 20 until said thumbscrew 38 is located adjacent to a predetermined opening 40 as illustrated in FIG. 3, said thumbscrew 38 is then turned until it extends through the said opening 40 in said strap 20 thereby securing said upper hook 18 in place. Thus with the adjustable hook 18 secured in place said upper window unit 12 may only be slid down relative to said lower window unit 13 and relative to said frame 11 until the said upper window unit 12 engages said lower hook 16 and said lower window unit 13 engages said upper hook 18 with said vertical portion 34 limiting horizontal motion of said upper hook 18 and thereby limiting the total window opening space. It can be seen that a person could open said window 10 for ventilation purposes and would feel secure in the knowledge that it could only be opened a predetermined amount thereby preventing unauthorized entry through said window 10. The position of said thumbscrew 38 in the said openings 40 permits the desired amount of permissible opening to be easily varied or changed from the inside by a person not being mechanically skilled and without tools.

Additional Embodiments

In addition to the above embodiment the invention could be applied to horizontally sliding windows and doors.

Alternatively to the above embodiments a frictional means of securing the upper hook in place on the steel strap could be used.

Alternatively to the above embodiments a levered cam action means of securing the upper hook in place on the steel strap could be used.

In addition to the above embodiments, by changing some dimensions the invention could be applied to frameless sliding units made of glass as well as many other materials.

In addition to the above embodiments if more than two sliding units are included in the overall frame additional adjustable window security clamps can be used to secure the overall window opening.

### CONCLUSIONS, RAMIFICATIONS AND SCOPE

Thus the reader will see that the adjustable window security clamp of the invention provides a device that is inexpensive, simple to install, adjust and remove without tools, which is able to be used for more than one window and allows the windows to be closed without any further adjustment.

While my above description contains many specifications, these should not be construed as limitations on the scope of the invention, but rather as an exemplification of some preferred embodiments thereof. Many other variations are possible. For example the materials used can be but are not limited to metals, alloys, plastics, fibers or other man made materials, the production methods can be but are not limited to rolling, machining, stamping, pressing, molding, casting or other forming and the base materials can be further covered with protective materials such as but not limited to painting, plating, coating or padding.

Accordingly, the scope of the invention should be determined not by the embodiments illustrated, but by the appended claims and their legal equivalents.

I claim:

1. An adjustable window security device for allowing one or more window units to be opened only up to a predetermined amount within the overall window frame comprising:
a. a flat rectangular strap, said member having a predetermined cross-sectional shape,
b. a first clamp member to be rigidly attached onto one end of said strap so as to, together, form a hook,
c. said strap being slid between two window units so that the said first clamp member rests under and round one of the window units.
d. a second clamp member slidably embracing said strap, vertically opposed too and on the opposite side of said strap to said first clamp member with an integral means for locking said second clamp member at a predetermined location on said strap, thereby forming a stationary opposed hook to that formed by the said first clamp member,
e. the fixed hooks formed by said first clamp member and said second clamp member being secured in a predetermined location on said strap thereby limiting the maximum travel of one window unit over and relative to another within the overall window frame,
whereby allowing one or more window units to be opened only up to a predetermined amount within the said overall window frame.

2. The adjustable window security device of claim 1 wherein said strap is of such dimensions and flexibility to pass between said two window units which are in a fully closed position without causing damage.

3. The adjustable window security device of claim 1 wherein the device can be installed, adjusted and removed without the use of tools.
